(19) United States
(12) Patent Application Publication
(10) Pub. No.: US 2010/0223816 A1
(43) Pub. Date: Sep. 9, 2010

(54) FOOTWEAR FOR DISPLAYING VISUAL CONTENT

(76) Inventor: Dante Barfield, Cincinnati, OH (US)

Correspondence Address: JAY M. SCHLOFF, 6960 Orchard Lake Road, Suite 315, West Bloomfield, MI, 48322, US

(21) Appl. No.: 12/399,103

(22) Filed: Mar. 6, 2009

(51) Int. Cl. A43B 23/00; G09G 3/36

(52) U.S. Cl. 36/136; 345/87

(57) ABSTRACT

A footwear for displaying visual content, such as logos and images, includes an upper member, a sole member, a controller unit, a display screen, and a power source. The sole member is coupled to the upper member. The controller unit is capable of storing the visual content, and, is adapted to be configured within one of the upper member and the sole member. The display screen is operatively coupled to the controller unit for receiving the visual content from the controller unit, and, is adapted to be mounted on a surface of the upper member for displaying the visual content. The power source is operatively coupled to the display screen and to the controller unit for providing power to the display screen and to the controller unit. The power source is adapted to be configured within one of the upper member and the sole member.

### FIELD OF THE INVENTION

The present invention relates generally, to footwear, and, more particularly, to a footwear capable of displaying visual content, such as logos, symbols, numbers, and images.

### BACKGROUND OF THE INVENTION

With changing fashion trends, it has been observed that a segment of population indulges in decorating their respective apparels, such as footwear. Specifically, people decorate and aesthetically style their footwear for personalizing the footwear in order to seek attention from others towards their embellished footwear. Further, many footwear vendors use their footwear products to advertise their brands. More particularly, the footwear vendors represent their characteristic traits, such as trademarks, logos, advertisement materials, and the like, on the footwear products. For example, the footwear vendors may embed their respective characteristic traits on the footwear products for embellishing the footwear products. Accordingly, such footwear vendors enjoy the benefit of having their characteristic traits displayed by their customers whenever the customers wear embellished footwear.

Conventionally, embedding such characteristic traits onto footwear for embellishment thereof involves techniques, such as silk screening; sewing by “tackle twill”; employing light emitting diodes (LEDs) that glow for providing an aesthetic appearance to the footwear; and affixing stickers that include images, logos, and the like. However, use of such techniques may gradually result in wearing of embellishments leaving the footwear with an unaesthetic appearance. Further, users of the embellished footwear tend to feel unsatisfied over a period because of a monotonous appearance of the footwear. For example, use of the stickers is incapable of providing flexibility for altering an appearance of a footwear, as the stickers are incapable of depicting diversified representation of visual content (such as logos, symbols, numbers, and images), when affixed onto the footwear. Accordingly, in order to alter the appearance of the footwear, it is necessary to change the stickers affixed on the footwear. Therefore, use of the conventional techniques for decorating a footwear fails to allow a user to freely customize and/or personalize his/her footwear in order to remain enriched with the updated fashion trends and practices.

Accordingly, there exists a need for precluding a monotonous appearance of a user's footwear while allowing the user to personalize and/or customize his/her footwear.

### SUMMARY OF THE INVENTION

In view of the forgoing disadvantages inherent in the prior-art, the general purpose of the present invention is to preclude a monotonous appearance of a user's footwear, to include all advantages of the prior art, and to overcome the drawbacks inherent in the prior art.

An object of the present invention is to preclude a monotonous appearance of a user's footwear while allowing the user to personalize and/or customize his/her footwear.

To achieve the above object, the present invention provides a footwear for displaying visual content. The footwear comprises an upper member, a sole member, a controller unit, a display screen, and a power source. The sole member is coupled to the upper member. The controller unit is capable of storing the visual content. The controller unit is adapted to be configured within one of the upper member and the sole member. The display screen is operatively coupled to the controller unit for receiving the visual content from the controller unit. The display screen is adapted to be mounted on a surface of the upper member for displaying the visual content. The power source is operatively coupled to the display screen and to the controller unit for providing power to the display screen and to the controller unit. The power source is adapted to be configured within one of the upper member and the sole member.

The footwear of the present invention is capable of being personalized and/or customized with diversified representation of the visual content, in order to preclude a monotonous appearance of the footwear.

This together with the other aspects of the present invention, along with the various features of novelty that characterize the present invention, is pointed out with particularity in the claims annexed hereto and forms a part of the present invention. For a better understanding of the present invention, its operating advantages, and the specified object attained by its uses, reference should be made to the accompanying drawing and descriptive matter in which there are illustrated exemplary embodiments of the present invention.

### BRIEF DESCRIPTION OF THE DRAWING

The advantages and features of the present invention will become better understood with reference to the following detailed description and claims taken in conjunction with the accompanying drawing, and in which:

FIG. 1 illustrates a perspective view of a footwear capable of displaying visual content, in accordance with an exemplary embodiment of the present invention.

### DETAILED DESCRIPTION OF THE INVENTION

The exemplary embodiments described herein detail for illustrative purposes are subject to many variations in structure and design. It should be emphasized, however, that the present invention is not limited to a particular footwear for displaying visual content, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an,” as used herein do not denote a limitation of quantity, but rather denote the presence of at least one of the referenced item.

The term “visual content,” as used herein, refers to a set of information, and, may be represented in the form of logos, symbols, numbers, images, and the like.

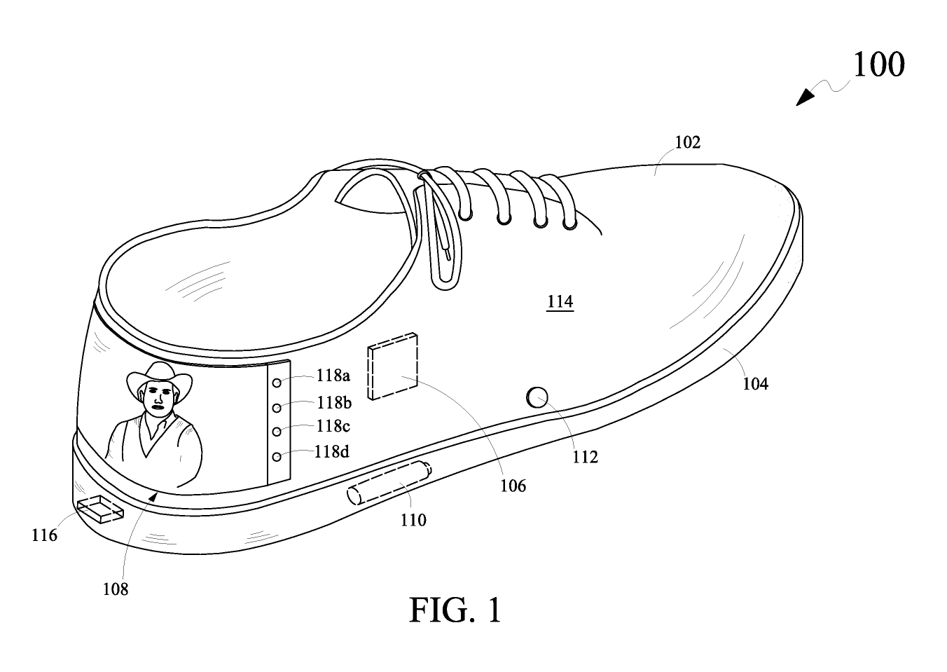

The present invention provides a footwear capable of displaying visual content, such as logos, symbols, numbers, and images. Specifically, the footwear of the present invention is capable of being personalized and/or customized with diversified representation of the visual content, in order to preclude a monotonous appearance of the footwear. The footwear of the present invention is explained in conjunction with FIG. 1.

Referring to FIG. 1, a perspective view of a footwear 100 capable of displaying visual content is illustrated, in accordance with an exemplary embodiment of the present invention. The footwear 100 includes an upper member 102, a sole member 104, a controller unit 106, a display screen 108, and a power source 110. The controller unit 106 is capable of storing the visual content. The display screen 108 is operatively coupled to the controller unit 106 for receiving the visual content from the controller unit 106. The power source 110 is operatively coupled to the display screen 108 and to the controller unit 106 for providing requisite power to the display screen 108 and to the controller unit 106.

The footwear 100 of the present invention further includes a power switch 112 operatively coupled to the power source 110 for regulating power supply from the power source 110 to the controller unit 106 and to the display screen 108.

It will be obvious to those skilled in the art that the footwear 100 of the present invention may include requisite electrical connections (not shown) and one or more electrical circuits (not shown) for providing operative couplings among the various elements, such as the controller unit 106, the display screen 108, the power source 110, and the power switch 112, of the footwear 100.

As shown in FIG. 1, the sole member 104 is coupled to the upper member 102 of the footwear 100. The upper member 102 is capable of receiving a foot of a user. The sole member 104 provides support to the upper member 102. Further, the controller unit 106 of the footwear 100 is adapted to be configured within one of the upper member 102 and the sole member 104 of the footwear 100. In the present embodiment, the controller unit 106 is configured within the upper member 102 of the footwear 100. Specifically, the controller unit 106 is received within the upper member 102, and, accordingly, the controller unit 106 is shown with dotted lines in FIG. 1.

Furthermore, the display screen 108 of the footwear 100 is mounted on a surface of the upper member 102. Specifically, the display screen 108 is mounted on an outer surface 114 at a rear portion (not numbered) of the upper member 102. In one embodiment of the present invention, the display screen 108 may be mounted on the outer surface 114 with the help of a fastening mechanism, such as glue and a plurality of screws. It will be evident to those skilled in the art that the display screen 108 is mounted on the upper member 102 in a manner such that the display screen 108 is operatively coupled to the controller unit 106 configured within the upper member 102.

Moreover, the power source 110 of the footwear 100 is adapted to be configured within one of the upper member 102 and the sole member 104. In the present embodiment, the power source 110 is configured within the sole member 104 of the footwear 100. Specifically, the power source 110 may be received within a closable opening (not shown) configured on a portion (not shown) of the sole member 104. Accordingly, the power source 110 is shown with dotted lines in FIG. 1. Further, in the present embodiment, the power source 110 is a rechargeable lithium battery. However, it will be obvious to those skilled in the art that the power source 110 may be a rechargeable alkaline battery.

The power switch 112 of the footwear 100 is operatively coupled to the power source 110 for regulating the power supply from the power source 110 to the controller unit 106 and to the display screen 108. The power switch 112 is adapted to be configured on the outer surface 114 of the upper member 102. The power switch 112 is a pressured button that may be used by a user of the footwear 100 for activating the display screen 108, which is operatively coupled to the controller unit 106.

As explained herein, the controller unit 106 is capable of storing the visual content. In the present embodiment of the present invention, the controller unit 106 is a microchip, which is capable of storing the visual content. It should be evident to a person skilled in the art that the controller unit 106 is further capable of receiving the visual content. The footwear 100 further includes an electrical interface 116 configured with the controller unit 106 for receiving the visual content. Specifically, the electrical interface 116 may be configured within one of the upper member 102 and the sole member 104, such that, the electrical interface 116 is accessible to the user for providing additional information to be displayed as the visual content on the display screen 108. For the purpose of this description, the electrical interface 116 is configured within the sole member 104 of the footwear 100. Accordingly, the electrical interface 116 is shown with dotted lines in FIG. 1.

The electrical interface 116 may enable the controller unit 106 to receive the visual content from a computer network, such as internet. Further, the visual content received through the electrical interface 116 may be stored in the controller unit 106. A suitable example of the electrical interface 116 may be a Universal Serial Bus (USB) interface, which enables the controller unit 106 to receive the visual content. Accordingly, a user of the footwear 100 may be able to provide a specific type of visual content to the controller unit 106, as per his/her preference with the help of the electrical interface 116. Specifically, information with regard to the visual content that may be stored within and retrieved from the controller unit 106, may further be updated via the electrical interface 116.

The controller unit 106 is further capable of providing the visual content to the display screen 108 for a digital display of the visual content on the display screen 108. Specifically, the display screen 108 serves as a digital display monitor that projects the visual content thereon. In the present embodiment, the display screen 108 is a Liquid Crystal Display (LCD) screen, which is capable of digitally displaying the visual content thereon. However, it may be evident to those skilled in the art that the display screen 108 may be an Organic Light Emitting Diode (OLED) screen or a plasma screen, which is capable of digitally displaying the visual content thereon. In one embodiment of the present invention, the display screen 108 may have a rectangular shape with a width of about 2.5 inches and a length of about 3 inches. Further, the display screen 108 may be a water-resistant screen, and accordingly, the footwear 100 may be worn by a user at any time irrespective of the adverse weather conditions, such as rainy weather conditions.

Further, in the present embodiment of the present invention, the display screen 108 is configured with a plurality of menu buttons, such as menu buttons 118a, 118b, 118c, and 118d (hereinafter collectively referred to as menu buttons 118a-d), for operating the display screen 108. Specifically, the menu button 118a is a display screen button, which may be configured for bringing the display screen 108 to an “ON” mode or an “OFF” mode. Further, the menu button 118b may be configured for adjusting a visual quality, such as brightness and contrast, of the display screen 108. Furthermore, the menu button 118c may be configured for indicating a status of the power source 110. Moreover, the menu button 118d may be configured for accessing the visual content from the controller unit 106. It will be evident to a person skilled in the art that the display screen 108 may include other such menu buttons for indicating other status updates.

In use, a user wears the footwear 100 in his/her foot. Heretofore, the present invention has been described with respect to a footwear, such as the footwear 100, for a foot of the user. However, it will be evident to those skilled in the art that, the user may wear a pair of footwear, such as the footwear 100, in his/her feet. Further, in use, the user may initially press the power switch 112 for enabling the power source 110 to provide the power supply to the controller unit 106 and to the display screen 108. Thereafter, the user may operate the display screen 108 with the help of the menu buttons 118a-d for displaying the visual content on the display screen 108.

For example, the user may press the menu button 118a for bringing the display screen 108 to the “ON” mode. Thereafter, the user may press the menu button 118b for adjusting the visual quality, such as the brightness and the contrast, of the display screen 108. Further, the user may press the menu button 118d for accessing the visual content from the controller unit 106. Specifically, the user may press the menu button 118d for retrieving the visual content stored in the controller unit 106, and thereafter digitally displaying the retrieved visual content on the display screen 108. For example, a retrieved visual content may be related to an image of the user's favorite sportsperson, to be displayed on the display screen 108, as shown in FIG. 1. Furthermore, the user may press the menu button 118d for selecting and then displaying different types of visual content stored in the controller unit 106, based on his/her fashion style.

The user may further press the menu button 118c for checking the status of the power source 110. Specifically, the user may press the menu button 118c for determining status on utilization of the power source 110, at any time. Accordingly, depending on the status on utilization of the power source 110, the user may re-charge the power source 110 for a subsequent use of the power source 110. Specifically, when the power source 110 has been completely utilized, the power source 110 may then be removed from the sole member 104 of the footwear 100. Thereafter, the power source 110 may be re-charged, and may again be configured within the sole member 104 for the re-use of the power source 110.

The footwear 100 as explained herein in conjunction with FIG. 1 may be subjected to many variations. For example, the footwear 100 may include a charging port (not shown) configured on one of the upper member 102 and the sole member 104 of the footwear 100. The charging port may be used for re-charging of the power source 110, thereby precluding a need of removing the power source 110 from the sole member 104 for the re-charging thereof. Further, the footwear 100 may include a logo (not shown) having a digital format. Such logo may be related to a specific footwear vendor for a footwear, such as the footwear 100, for digitally displaying a name or a brand of the footwear vendor.

Additionally, the footwear 100 may be designed in variable sizes depending on age of a user and/or size of foot of the user. Accordingly, the footwear 100 may be designed for individuals of different age groups. Further, the various elements, such as the display screen 108, of the footwear 100 may be designed to have a specific shape and a specific size, based on a manufacture's preference.

The footwear, such as the footwear 100, provides an easy display of visual content thereon, based on a user's preference with regard to updated fashion trends and practices. Accordingly, the footwear is capable of displaying a diversified representation of the visual content, in order to preclude a monotonous appearance of the footwear. Specifically, the footwear provides liberty to a user, for personalizing and/or customizing the footwear, as per his/her desire. More specifically, the footwear is provided with plurality of menu buttons, such as the menu buttons 118a-d, for enabling the user to customize settings for displaying the visual content based on his/her fashion preferences. Further, the footwear may be utilized for an advertising purpose. For example, the footwear may display advertisement content related to products and services of various footwear vendors for endorsement and promotion purposes.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A footwear comprising:
an upper member;
a sole member coupled to the upper member;
a controller unit capable of storing visual content, the controller unit adapted to be configured within one of the upper member and the sole member;
a display screen operatively coupled to the controller unit for receiving the visual content from the controller unit, and, adapted to be mounted on a surface of the upper member for displaying the visual content; and
a power source operatively coupled to the display screen and to the controller unit for providing power to the display screen and to the controller unit, and, adapted to be configured within one of the upper member and the sole member.

2. The footwear of claim 1, wherein the display screen is a Liquid Crystal Display (LCD) screen.

3. The footwear of claim 1, wherein the display screen is configured with a plurality of menu buttons for operating the display screen.

4. The footwear of claim 1, wherein the controller unit is a microchip capable of storing the visual content and capable of providing the visual content to the display screen.

5. The footwear of claim 1, further comprising an electrical interface configured with the controller unit for receiving the visual content.

6. The footwear of claim 5, wherein the electrical interface is a Universal Serial Bus (USB) interface.

7. The footwear of claim 1, wherein the power source is a rechargeable lithium battery.

8. The footwear of claim 1, further comprising a power switch operatively coupled to the power source for regulating power supply from the power source to the controller unit and to the display screen, and, adapted to be configured on the surface of the upper member.
